(19) United States
(12) Patent Application Publication
(10) Pub. No.: US 2007/0239931 A1
(43) Pub. Date: Oct. 11, 2007

(54) System, apparatus, integrated circuit thereof, and method for recording data on optical storage medium

(76) Inventors: Hsin-Cheng Chen, Tainan County (TW); Ping-Sheng Chen, Jhongpu Township (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/390,607

(22) Filed: Mar. 28, 2006

(51) Int. Cl. G06F 13/00

(52) U.S. Cl. 711/111

(57) ABSTRACT

A system for recording a data on an optical storage medium comprises an apparatus. The apparatus includes an integrated circuit, a data buffer, and a microprocessor. The system separates data preparation operations and encoding operations so the recording performance is improved. A method for recording a data on an optical storage medium comprises the following steps: generating a set of data prepare batch values; providing a data prepare batch controller to generate a set of data prepare control signals in response to the set of data prepare batch values; and providing a data prepare circuit to prepare the data in response to the set of data prepare control signals.

### CROSS-REFERENCES TO RELATED APPLICATIONS

Not applicable.

### BACKGROUND OF THE INVENTION

1. Field of the Invention

The present invention relates to a system, an apparatus, an integrated circuit, and a method for recording a data on an optical storage medium; in particular, relates to a system, an apparatus, an integrated circuit, and a method for processing and preparing a recorded data.

2. Descriptions of the Related Art

Many conventional computer systems comprise an optical disc driver for recording a data on an optical disc. One example of the conventional computer systems is disclosed in U.S. Pat. No. 5,940,358. The computer system, illustrated in FIG. 1, is configured to record a data in a CD-R/CD-RW format.

The computer system comprises a host processor 103, a CD-R/CD-RW controller 105, a microprocessor 107, a data buffer manager 109, a data buffer 111, a RAM 115, a CD-ROM encoder 117, a CD encoder 119, and a CD-R/CD-RW driver 121. The host processor 103 sends a signal, including the data, and a command specifying corresponding information for recording the data. The CD-R/CD-RW controller 105 receives the data and the command from the host processor 103. The data is sent to the data buffer 111 via the data buffer manager 109 for temporary storage. The command is sent to the microprocessor 107, which generates a table in response to the command and stores it in the RAM 115. To generate control signals for the CD-R/CD-RW controller 105, the microprocessor 107 refers to the information in the table.

The CD-R/CD-RW controller 105 then generates a set of encoder control signals to control the operations of the CD-ROM encoder 117 and the CD encoder 119. The CD-ROM encoder 117 selects data from several data sources such as a host computer, a data repeater, a data buffer, etc., affixes a SYNC code, a header, sub-header information, and the like to the data to form a CD-ROM raw data, and rewrites the CD-ROM raw data in the data buffer 111 via the data buffer manager 109. Then, the CD-ROM encoder 117 reads the affixed CD-ROM raw data from the data buffer 111 via the data buffer manager 109 and encodes it with an error detection code (EDC), an error correction code (ECC), and a scrambling operation to form a CD-ROM encoded data. The CD-ROM encoded data is then stored in the data buffer 111 via the data buffer manager 109. The CD encoder 119 is configured to perform a CIRC (Cross Interleaved Reed-Solomon Code) calculation on the CD-ROM encoded data to form a CD encoded data. The CD encoder 119 also generates a subcode that is to be affixed to the CD encoded data. After affixation, the subcode together with the CD encoded data is subjected to EFM (Eight to Fourteen Modulation) and merging-bit insertion to form a modulated data. Finally, a frame synchronization signal is added to the modulated data. The modulated data with the frame synchronization signal is ready to be recorded via the CD-R/CD-RW driver 121.

One shortcoming is that the microprocessor 107 makes a large number of accesses to the RAM 115 during the time of retrieving the information from the table. Such highly frequent accesses cause that the microprocessor 107 might fail to generate entire control signals promptly due to its limited operating speed. Under the circumstances, the CD-R/CD-RW controller 105 does not receive the appropriate instructions from the microprocessor 107. The data preparation and encoding of the CD-ROM encoder 117 and the CD encoder 119 will hence generate incomplete or even wrong data for CD-R/CD-RW driver 121 to record on an optical disc.

In addition to the CD format, there are many new optical disc formats appearing on the market, such as a DVD format, a HD-DVD format, or a Blu-ray format. These new formats have different definitions, for example, in the lead-in, middle zone, lead-out, and linking area. Therefore, the structure shown in FIG. 1 is unable to satisfy the recording operations in the new formats, especially at a high speed.

Moreover, the lead-in for high speed recording is another problem. If the data to be recorded on the optical disc requires space of two layers, a middle area data is then necessary to be inserted to provide information for layer jumping. FIG. 2(a) illustrates the layer-jumping recording sequences, wherein a layer 0 data 201 is one part of the data for recording on the layer 0 of the optical disc, a layer 1 data 203 is the other part of the data for recording on the layer 1 of the optical disc, and a middle area data 205 is the information recorded on the end of the layer 0 to inform of layer ending. The layer 0 data 201 and the layer 1 data 203 are sent by the host processor 103; however, the middle area data 205 is generated by the CD encoder 119. As FIG. 2(b) shows, the middle area data 205 must be inserted right after the layer 0 data 201. For high speed recording, it is difficult to accomplish the insertion in time because the insertion involves buffer switching.

Due to the drawbacks, a system or an apparatus for recoding a data on an optical storage medium with at a high speed and in a different format is critically needed in the industrial field.

### SUMMARY OF THE INVENTION

One object of this invention is to provide a system for recording a data on an optical storage medium. The system comprises a microprocessor, a data prepare batch controller, and a data prepare circuit. The microprocessor is configured to generate a set of data prepare batch values. The data prepare batch controller is configured to generate a set of data prepare control signals in response to the set of data prepare batch values. The data prepare circuit is configured to prepare the data in response to the set of data prepare control signals.

Another object of this invention is to provide an apparatus for recording a data on an optical storage medium. The apparatus comprises a microprocessor, a data prepare batch controller, and a data prepare circuit. The microprocessor is configured to generate a set of data prepare batch values. The data prepare batch controller is configured to generate a set of data prepare control signals in response to the set of data prepare batch values. The data prepare circuit is configured to prepare the data in response to the set of data prepare control signals.

Another object of this invention is to provide an integrated circuit for processing a data in order to be recorded on an optical storage medium. The integrated circuit is electrically connected to a microprocessor which generates a set of data prepare batch values. The integrated circuit comprises a data prepare batch controller, and a data prepare circuit. The data prepare batch controller is configured to generate a set of data prepare control signals in response to the set of data prepare batch values. The data prepare circuit is configured to prepare the data in response to the set of data prepare control signals.

Yet a further object of this invention is to provide a method for recording a data on an optical storage medium. The method comprises the following steps: generating a set of data prepare batch values; providing a data prepare batch controller to generate a set of data prepare control signals in response to the set of data prepare batch values; and providing a data prepare circuit to prepare the data in response to the set of data prepare control signals.

Recording a data on an optical storage medium by utilizing this invention has the advantage of high speed and is capable of selecting a recording format of the data from many formats.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating a conventional multi-media system;

FIG. 2(a) is a schematic of a layer-jumping recording sequence;

FIG. 2(b) is a schematic of a conventional computer system failing to insert a middle area data;

FIG. 3 is a block diagram illustrating an embodiment of the present invention;

FIG. 4 is a block diagram illustrating another embodiment of the present invention;

FIG. 5 is a schematic diagram illustrating how the present invention supports different multi-media formats;

FIG. 6(a) illustrates one solution for inserting a middle area data;

FIG. 6(b) illustrates another solution for inserting the middle area data; and

FIG. 7 is a flow chart illustrating a method for recording a data on an optical storage medium in a system.

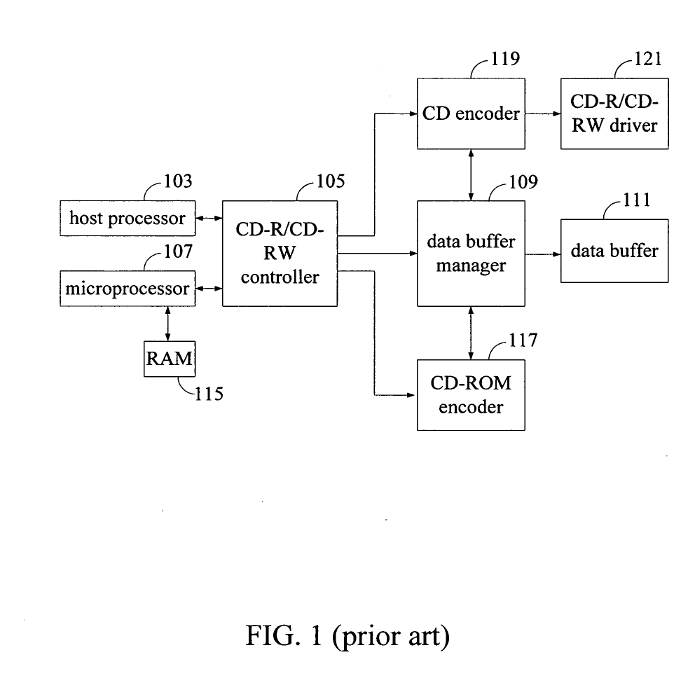

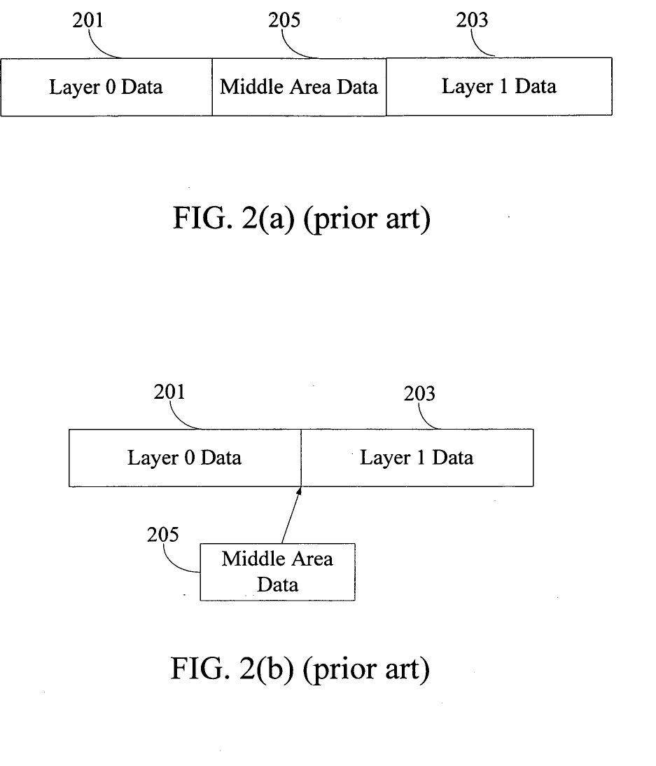

### DESCRIPTION OF THE PREFERRED EMBODIMENT

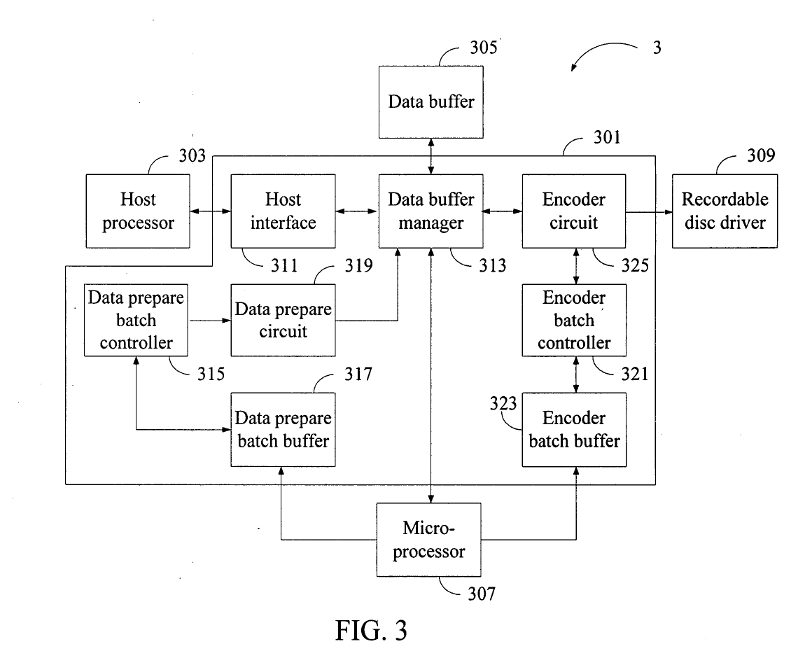

One embodiment of the present invention is a computer system having an apparatus, i.e., an optical disc driver for recording a data on an optical disc as illustrated in FIG. 3. The computer system 3 includes a host processor 303. The optical disc driver includes an integrated circuit 301 and a microprocessor 307. The integrated circuit 301, electrically connected to the microprocessor 307, includes a host interface 311, a data prepare batch controller 315, and a data prepare circuit 319.

The integrated circuit 301 is configured to process a data so that the data can be recorded on an optical disc. When users input instructions to record a data on an optical disc, the host processor 303 sends an information data and a command to the host interface 311. The command is a CUE-sheet (coordinating users exchange-sheet) command. The host interface 311 is configured to receive the information data and the command, wherein the host interface 311 may be any standard interface such as a small computer system interface (SCSI) or an Advanced Technology Attachment Packet Interface (ATAPI). The microprocessor 307 is configured to generate a set of data prepare batch values for data preparation operations in response to the command. The data prepare batch controller 315 is configured to generate a set of data prepare control signals in response to the set of data prepare batch values. The data prepare circuit 319 is configured to prepare and arrange the data in response to the set of data prepare control signals. The data may be prepared with an ID error detection code, an error detection code, or a scramble operation.

More particularly, the integrated circuit 301 further includes a data buffer manager 313, a data prepare batch buffer 317 and the optical disc driver further includes a data buffer 305 connected to the data buffer manager 313. The data buffer manager 313 is configured to receive the information data and the command from the host interface 311 and to send the command to the microprocessor 307. The data buffer 305 is configured to store the information data sent by the data buffer manager 313. The data prepare batch buffer 317 is configured to store the set of data prepare batch values from the microprocessor 307. When the data prepare batch controller 315 needs to retrieve the set of data prepare batch values to control the data prepare circuit 319 to prepare and arrange the data for recording, the data prepare batch buffer 317 transmits them to a register of the data prepare batch controller 315 in a certain order and length. After the data prepare circuit 319 prepares and arranges the data to be recorded, the data is stored in the data buffer 305 via the data buffer manager 313 and the data preparation is, hence, completed.

The integrated circuit 301 further includes an encoder batch controller 321, an encoder batch buffer 323 and an encoder circuit 325. The optical disc driver further includes a recordable disc driver 309. The microprocessor 307 also generates a set of encoder batch values for encoding operations in response to the command. The encoder batch buffer 323 is configured to store the set of encoder batch values from the microprocessor 307. The encoder batch controller 321 is configured to generate a set of encoder control signals in response to the set of encoder batch values. In other words, when the encoder batch controller 321 needs to retrieve the set of encoder batch values, the encoder batch buffer 323 transmits them to a register of the encoder batch controller 321 in a certain order and length. The encoder circuit 325 retrieves the prepared data from the data buffer 305 and generates a signal carrying the prepared data in response to the set of encoder control signals. The signal may be generated by encoding the prepared data with an error correction code, conducting an interleave operation, or modulating the prepared data according to a modulation table or a rule. The recordable disc driver 309 is configured to record the prepared data carried by the signal on an optical disc via laser. The optical disc may be, for example, a CD-R/RW disc, a DVD+R/RW disc, a DVD-R/RW disc, a RAM disc, a HD-DVD R/RW disc, or a Blu-ray R/RW disc.

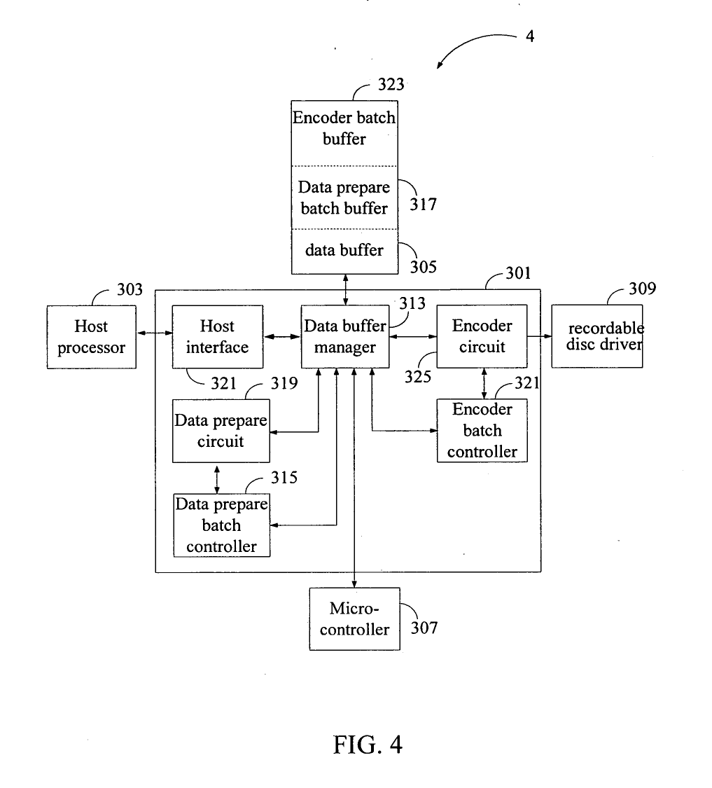

Another embodiment of the present invention is a computer system 4 for recording a data on an optical disc as illustrated in FIG. 4. In contrast with the first embodiment, the data prepare batch buffer 317 and the encoder batch buffer 323 of the second embodiment are incorporated with the data buffer 305, whereby the second embodiment saves the layout area of the integrated circuit 301. When a set of data prepare batch values is required to be stored in the data prepare batch buffer 317 or a set of data prepare batch values is required to be retrieved from the data prepare batch buffer 317, the data buffer manager 313 handles the transmission. When a set of encoder batch values is required to be stored in the encoder batch buffer 323 or a set of encoder batch values is required to be retrieved from the encoder batch buffer 323, the data buffer manager 313 also handles the transmission.

As described above, the microprocessor 307 of the first and the second embodiments sends the set of data prepare batch values and the set of encoder batch values to the data prepare batch buffer 317 and encoder batch buffer 323, respectively. The set of data prepare batch values and the set of encoder batch values, in response to the microprocessor 307's requests, are written into the registers of the data prepare batch controller 315 and the encoder batch controller 321, respectively. Therefore, the microprocessor 307 simply needs to send the aforementioned sets of values so frequent accesses are unnecessary. The microprocessor 307 is no longer a performance bottleneck in the computer system as the prior art. The present invention successfully improves performance accordingly.

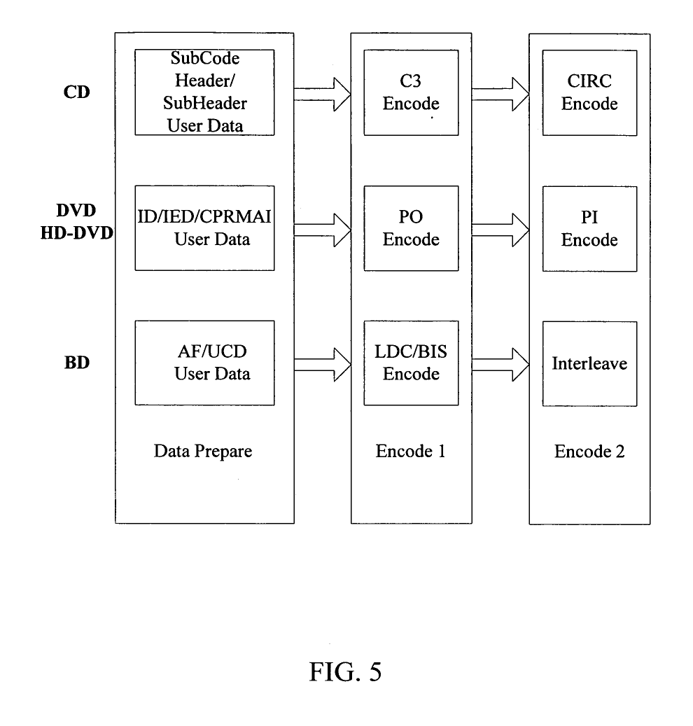

Since the data preparation operations and the encoding operations of the present invention are separate, a data may be recorded in several formats but not in a CD format only. In other words, the data preparation operations of the present invention are adapted to establish a desired format directly without additional conversion of the CD format. FIG. 5 shows some examples. When a data is required to be recorded in a CD format, the data preparation operations establish the information of Sub Code, Header, Sub Header, User Data and the encoding operations first encodes the data with C3 code and then encodes with CIRC code. When a data is required to be recorded in a DVD/HD-DVD format, the data preparation operations establish the information of ID, IED, CPRMAI, User Data and the encoding operations first encodes the data with PO code and then encodes with PI code. When a data is required to be recorded in a Blu-ray format, the data preparation operations establish the information of AF, UCD, User Data and the encoding operations first encodes the data with LDC/BIS code and then performs interleaving.

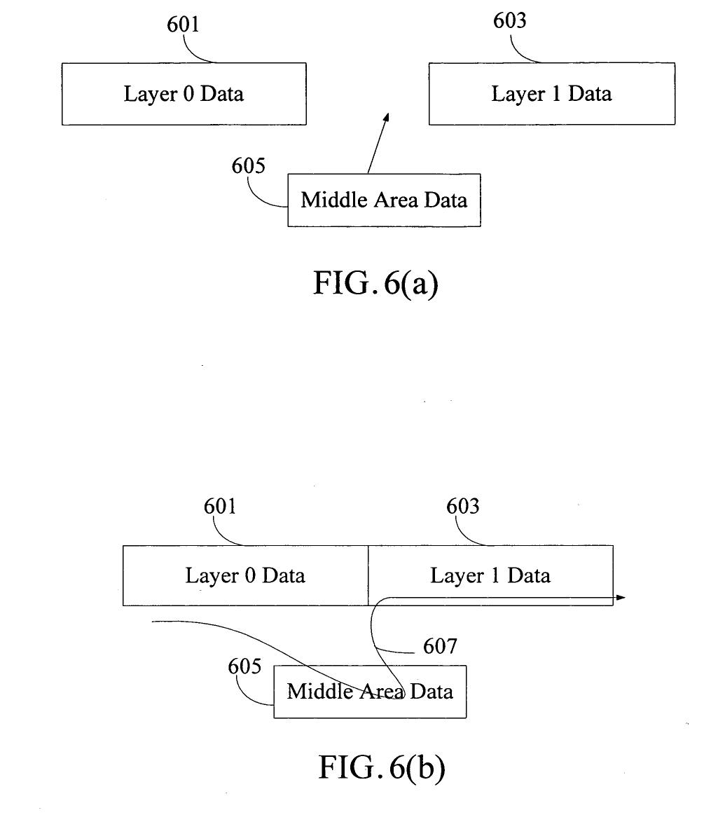

The present invention may easily solve the problem of the lead-in of the prior art. One solution, as shown in FIG. 6(a), is to store a layer 0 data 601, a layer 1 data 603 and a middle area data 605 in the same buffer, such as the arrangement of the data prepare batch buffer 317, the encoder batch buffer 323, and the data buffer 305 in the second embodiment. This kind of arrangement does not require buffer switching when the recording involves the space of two layers. Another solution, as shown in FIG. 6(b), is to proceed with recording in the sequence 607. Since the present invention separates the hardware of data preparation and encoder batch, the signals for controlling the two operations are also separated so that burning the middle area data 605 right after the layer 0 data 601 may be finished without delay.

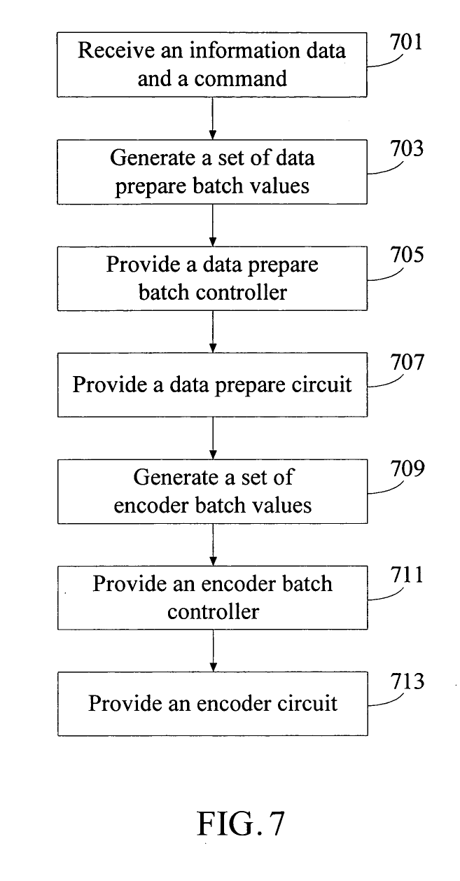

FIG. 7 shows an exemplary method for an optical disc driver to record a data on an optical disc in accordance with the present invention. In step 701, an information data and a command are received. In step 703, a set of data prepare batch values is generated in response to the command. In step 705, a data prepare batch controller is provided to generate a set of data prepare control signals in response to the set of data prepare batch values. In step 707, a data prepare circuit is provided to prepare the data for recording in response to the set of data prepare control signals. In step 709, a set of encoder batch values is generated in response to the command. In step 711, an encoder batch controller is provided to generate a set of encoder control signals in response to the set of encoder batch values. In step 713, an encoder circuit is provided to generate a signal carrying the data in response to the set of encoder control signals. The optical disc driver may record the data, based on the signal, in several formats. It is noted that the present invention does not limit the execution orders of the above steps. For example, step 709 may be executed at any time after step 701 is executed.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A system for recording a data on an optical storage medium, comprising:
a microprocessor for generating a set of data prepare batch values;
a data prepare batch controller for generating a set of data prepare control signals in response to the set of data prepare batch values; and
a data prepare circuit for preparing the data in response to the set of data prepare control signals.

2. The system as claimed in claim 1, further comprising a host processor for sending an information data and a command.

3. The system as claimed in claim 2, further comprising a data buffer manager for receiving the information data and the command from the host processor and for sending the command to the microprocessor.

4. The system as claimed in claim 3, further comprising a data buffer for storing the information data sent by the data buffer manager.

5. The system as claimed in claim 1, further comprising a data prepare batch buffer for storing the set of data prepare batch values, wherein the data prepare batch controller retrieves the set of data prepare batch values from the data prepare batch buffer.

6. The system as claimed in claim 2, wherein the microprocessor further generates a set of encoder batch values in response to the command.

7. The system as claimed in claim 6, further comprising an encoder batch controller for generating a set of encoder control signals in response to the set of encoder batch values.

8. The system as claimed in claim 7, further comprising an encoder circuit for generating a signal carrying the data in response to the set of encoder control signals.

9. The system as claimed in claim 8, further comprising a recordable disc driver for recording the data in response to the signal.

10. The system as claimed in claim 7, further comprising an encoder batch buffer for storing the set of encoder batch values, wherein the encoder batch controller retrieves the set of encoder batch values from the encoder batch buffer.

11. An apparatus for recording a data on an optical storage medium, comprising:
a microprocessor for generating a set of data prepare batch values;
a data prepare batch controller for generating a set of data prepare control signals in response to the set of data prepare batch values; and
a data prepare circuit for preparing the data in response to the set of data prepare control signals.

12. The apparatus as claimed in claim 11, further comprising a host interface for receiving an information data and a command.

13. The apparatus as claimed in claim 12, further comprising a data buffer manager for receiving the information data and the command from the host interface and for sending the command to the microprocessor.

14. The apparatus as claimed in claim 13, further comprising a data buffer for storing the information data sent by the data buffer manager.

15. The apparatus as claimed in claim 11, further comprising a data prepare batch buffer for storing the set of data prepare batch values, wherein the data prepare batch controller retrieves the set of data prepare batch values from the data prepare batch buffer.

16. The apparatus as claimed in claim 12, wherein the microprocessor further generates a set of encoder batch values in response to the command.

17. The apparatus as claimed in claim 16, further comprising an encoder batch controller for generating a set of encoder control signals in response to the set of encoder batch values.

18. The apparatus as claimed in claim 17, further comprising an encoder circuit for generating a signal carrying the data in response to the set of encoder control signals.

19. The apparatus as claimed in claim 17, further comprising an encoder batch buffer for storing the set of encoder batch values, wherein the encoder batch controller retrieves of the set of encoder batch values from the encoder batch buffer.

20. An integrated circuit for processing a data in order to be recorded on an optical storage medium, the integrated circuit being electrically connected to a microprocessor, the microprocessor generating a set of data prepare batch values, the integrated circuit comprising:
a data prepare batch controller for generating a set of data prepare control signals in response to the set of data prepare batch values; and
a data prepare circuit for preparing the data in response to the set of data prepare control signals.

21. The integrated circuit as claimed in claim 20, further comprising a host interface for receiving an information data and a command, the set of data prepare batch values being generated in response to the command.

22. The integrated circuit as claimed in claim 21, further comprising a data buffer manager for receiving the information data and the command from the host interface and for sending the command to the microprocessor.

23. The integrated circuit as claimed in claim 22, wherein the integrated circuit is electrically connected to a data buffer for storing the information data sent by the data buffer manager.

24. The integrated circuit as claimed in claim 20, further comprising a data prepare batch buffer for storing the set of data prepare batch values, wherein the data prepare batch controller retrieves the set of data prepare batch values from the data prepare batch buffer.

25. The integrated circuit as claimed in claim 21, wherein the microprocessor further generates a set of encoder batch values in response to the command.

26. The integrated circuit as claimed in claim 25, further comprising an encoder batch controller for generating a set of encoder control signals in response to the set of encoder batch values.

27. The integrated circuit as claimed in claim 26, further comprising an encoder circuit for generating a signal carrying the data in response to the set of encoder control signals.

28. The integrated circuit as claimed in claim 26, further comprising an encoder batch buffer for storing the set of encoder batch values, wherein the encoder batch controller retrieves the set of encoder batch values from the encoder batch buffer.

29. A method for recording a data on an optical storage medium, comprising the steps of:
generating a set of data prepare batch values;
providing a data prepare batch controller to generate a set of data prepare control signals in response to the set of data prepare batch values; and
providing a data prepare circuit to prepare the data in response to the set of data prepare control signals.

30. The method as claimed in claim 29, further comprising the step of receiving an information data and a command.

31. The method as claimed in claim 30, further comprising the step of generating a set of encoder batch values in response to the command.

32. The method as claimed in claim 31, further comprising the step of providing encoder batch controller to generate a set of encoder control signals in response to the set of encoder batch values.

33. The method as claimed in claim 32, further comprising the step of providing an encoder circuit to generate a signal carrying the data in response to the set of encoder control signals.
